(19) United States
(12) Patent Application Publication
(10) Pub. No.: US 2009/0192943 A1
(43) Pub. Date: Jul. 30, 2009

(54) Renewing an Expired License

(75) Inventors: Kedarnath A. Dubhashi, Redmond, WA (US); Kenneth S. Reneris, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/021,281

(22) Filed: Jan. 28, 2008

(51) Int. Cl. G06Q 10/00; H04L 9/32

(52) U.S. Cl. 705/59

(57) ABSTRACT

This document describes tools capable of renewing an expired license to entertainment content. The tools, in some embodiments, may repeatedly renew a license using very little resources, such as by forgoing retention of the license, encryption keys, or the entertainment content between renewals. The tools, for example, may provide a license to a particular content receiver (e.g., a laptop computer), and, when that license expires, renew the license with as little as a single retained secret. By so doing the tools enable, among other things, fewer computing resources to be used in renewing a license while maintaining the security of that license's entertainment content.

### BACKGROUND

Users enjoy entertainment content in many different ways. Users can enjoy content in ways dictated by a traditional content distributor such as a radio station or movie theater by listening to songs on the radio or watching movies in the theater. Users also enjoy content using physical media usually purchased from another type of content distributor, e.g., through purchasing songs on CD or movies on DVD from a store.

More recently, users have been able to access entertainment content digitally, such as through subscription services. These services may permit more-flexible ways to pay for and use content, including accessing content for a period of time, e.g., by subscribing to a service that allows them to play a particular song on their MP3 player for 30 days.

These newer distribution services, however, have had significant challenges to overcome. In order to keep entertainment content secure, for example, some content distributors use significant resources to distribute entertainment content. In many cases these significant resources are also used each time a user desires to continue using entertainment content, such as when a user's license to the content expires and he or she wishes to renew that license.

### SUMMARY

This document describes tools capable of renewing an expired license to entertainment content. The tools, in some embodiments, may repeatedly renew a license using very little resources, such as by forgoing retention of the license, encryption keys, or the entertainment content between renewals. The tools, for example, may provide a license to a particular content receiver (e.g., a laptop computer), and, when that license expires, renew the license with as little as a single retained secret. By so doing the tools enable, among other things, fewer computing resources to be used in renewing a license while maintaining the security of that license's entertainment content.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “tools,” for instance, may refer to system(s) (including hardware cards), method(s), computer-readable instructions, and/or technique(s) as permitted by the context above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in which an example implementation of the tools may operate to renew an expired license to entertainment content.

FIG. 2 is an illustration of an example embodiment of a license to use entertainment content.

FIG. 3 is a flow diagram depicting a procedure in an example implementation in which a license is issued.

FIG. 4 is a flow diagram depicting a procedure in an example implementation in which a license is renewed.

FIG. 5 is an illustration of an example embodiment of a renewed license to use entertainment content.

### DETAILED DESCRIPTION

### Overview

To distribute entertainment content securely, some digital rights management (DRM) procedures encrypt entertainment content with a content key and then combine the encrypted content, a usage policy governing use of that content, and an encryption of the content key into a license. In the world of television tuners and personal computers, for example, a TV tuner may issue a license to entertainment content to a personal computer. The personal computer may then render the content to a user so long as such use is permitted by the usage policy.

These licenses, however, may expire. The usage policy may permit use of the entertainment content for a certain number of days or a certain number of uses. Once this time period has passed or the number of uses met, the usage policy may no longer permit the personal computer to use the entertainment content. Thus, if a user plays a song 100 times, copies a music video to other devices five times, or a subscription period for a movie expires, the usage policy may not permit the user's personal computer to continue to use the entertainment content.

Renewing the license, however, often uses significant resources or desires a particular procedure. A TV tuner, for example, may not be capable of decrypting a content key/integrity combination because they are encrypted to the receiver of the entertainment content (e.g., the personal computer). Or such a tuner may not have sufficient capabilities to renew a license because of it not having sufficient database memory, such as by not having an integrated and/or cryptographically secure database. While some other entity, such as an online service, may be able to forgo renewing a license by providing a new license, this may also use significant resources.

The tools described herein address these and other challenges effective to renew expired licenses, in some embodiments using very little resources. The tools, for example, may provide a license to a laptop computer to play a movie for 30 days. When the license expires the tools may renew the license, such as by adding another 30 days, with as little as a single retained secret. The tools may use this secret to verify the integrity of the expired license and then also to digitally sign the license once renewed. In this example the tools do not retain anything other than the secret, though in some cases the tools may do so if desired. By so doing the tools enable, among other things, fewer computing resources to be used in renewing a license while maintaining the security of that license's entertainment content.

In the following discussion, an example environment is first described in which the tools may operate to renew an expired license. Example procedures and licenses are then described that may be employed in the example environment, as well as in other environments. Although these tools are often described as employed within a personal computing environment in the following discussion, it should be readily apparent that these tools may be incorporated within a variety of environments without departing from the spirit and scope thereof.

Example Environment

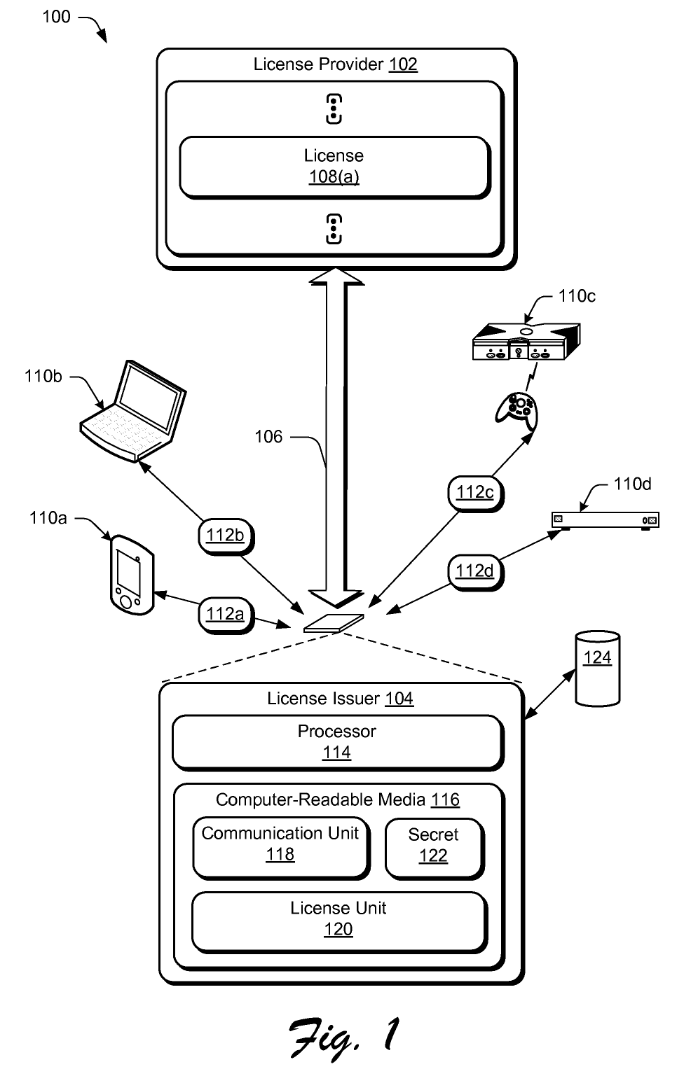

FIG. 1 is an illustration of an environment 100 in an example implementation in which the tools may operate to renew an expired license to entertainment content. Environment 100 includes a license provider 102 communicatively coupled to a license issuer 104 via a network connection 106 and having one or more licenses 108a (described below). The issuer is then communicatively coupled to any of four example content receivers 110a-110d through one of communication conduits 112a-112d.

In the following discussion, the license provider, license issuer, network connection, content receivers, and communication conduits may represent one or more entities and therefore reference may be made to a single entity (e.g., the content receiver 110) or multiple entities (e.g., the license providers 102). Additionally, although a single network connection 106 is shown, it may represent network connections achieved using a single network or multiple networks. Also, although four communication conduits 112 are shown, one for each content receiver, one or many for each content receiver may be used. Both the network connection and any of the communication conduits may be representative of a broadcast network with back-channel communication, an Internet Protocol (IP) network, and so on. Each communication conduit may also represent a physical, non-network communication, such as when the license issuer is a hardware card physically connected to or integral with the content receiver.

License issuer 104 may be configured in a variety of ways. For example, the license issuer may be configured as a server or other computer that is capable of communicating with or being integral with license provider 102. Thus, the license issuer may be a server communicatively coupled over a network (e.g., the Internet) through the communication conduit to content receiver 110. The license issuer in this example has a great a deal of capabilities, such as the ability to store extensive amounts of information (e.g., with a database), as well as large computational abilities. In other examples, however, the license issuer has limited capabilities, such as by not having a database or capability to retain significant amounts of information (e.g., entertainment content or a license to same). The license issuer, for example, may be a hardware card physically coupled to a computing device and have limited storage capabilities.

In FIG. 1 the license issuer is shown with a processor 114 and computer-readable media 116. The computer-readable media may comprise a communication unit 118, a license unit 120, and a secret 122.

In one example case the license issuer is a tuner, such as a cable or satellite television tuner used to receive entertainment content from the head of a satellite or cable source. This tuner has some limited memory but often no database. It may be capable of performing encryption, real-time processing, and other computations, however.

The license issuer, whether a tuner or not, however, may establish secure communication with license provider 102 and/or content receiver 110 using communication unit 118. In either case the communication can be over a secure authenticated channel. The license issuer may issue a license, sign that license, check the integrity of an expired license, and renew that license with license unit 120. The license issuer also maintains secret 122. This secret may be unique to the license issuer and may be stored within the hardware of the license issuer or in some other secure storage. As will be discussed in greater detail below, the license issuer may use the secret to help enable renewal of a license including without retaining or using other information between renewals.

Content receivers 110 may include a desktop computer, a mobile station, an entertainment appliance, a laptop, a mobile media player, a video game player, a wireless phone having interactive capabilities, and so forth. For purposes of the following discussion, the content receivers may also relate to a person or entity that operates the content receiver. In other words, when referring to content receiver 110 the reference may also be to a user that operates the content receiver or enjoys entertainment content provided (directly or indirectly) by the content receiver or to the reverse, as will be apparent from the context.

The content receiver and license issuer may be separate, such as when the license issuer is a server or physically integral, such as when the license issuer is a tuner plugged into the content receiver.

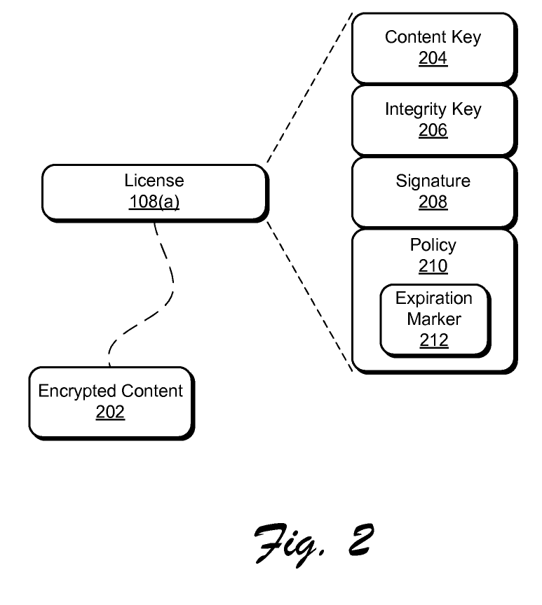

Returning to license provider 102, the license provider includes one or more licenses 108(a), where “a” can be any integer from 1 to “A”. The licenses 108(a) may be issued for a variety of data, such as entertainment content for music videos, songs, still images, gaming software, movies, television programming, and video-on-demand (VOD) files, and well as other renderable media or usable software or files. The licenses may also include cryptographic keys, content policies, and digital signatures. The licenses 108(a) or parts thereof are communicated over network connection 106 to license issuer 104 or, when the license provider and license issuer are integrated, are communicated internally. Licenses are described in greater detail in FIG. 2.

The license issuer may (e.g., in the case of the license issuer being a server) include or have access to memory 124, which may be configured in a variety of ways, such as a hard disk drive, a removable computer-readable medium (e.g., a writable digital video disc), semiconductor-based memory, and so on.

The license issuer is illustrated as executing the communication unit and the license unit using processor(s) 114 to facilitate license renewal. These units may include software as illustrated and be stored in computer-readable media 116. Processors are not limited by the materials from which they are formed or the processing mechanisms employed therein. For example, processors may be comprised of semiconductor(s) and/or transistors (e.g., electronic integrated circuits (ICs)). In such a context, processor-executable instructions of the units may be electronically-executable instructions. Additionally, although a single memory 124 is shown in communication with the license issuer 104, a wide variety of types and combinations of memory may be employed, such as random access memory (RAM), hard disk memory, removable medium memory, and other types of computer-readable media.

It should be noted that one or more of the entities shown in FIG. 1 may be further divided (e.g., license issuer 104 may be implemented by a plurality of servers in a distributed computing system), combined, and so on and thus the environment 100 of FIG. 1 is illustrative of one of a plurality of different environments that may employ or be usable by the described tools.

Generally, any of the functions described herein can be implemented using software, firmware, hardware (e.g., fixed-logic circuitry), manual processing, or a combination of these implementations. The term “unit” as used herein generally represents software, firmware, hardware, or a combination thereof.

In the case of a partial software implementation, communication unit 118 and license unit 120 represent some program code that performs specified tasks when executed on a processor (e.g., CPU or CPUs). The program code can be stored in one or more computer-readable memory devices, such as media 116 and/or memory 124. The tools for renewing licenses may be platform-independent, meaning that the tools may be implemented on a variety of commercial computing platforms having a variety of processors or even devices with limited memory resources, such as a television tuner that is a hardware card.

Example ways in which the elements of FIG. 1 and the tools in general may operate, as well as details about how each may securely communicate with other entities are set forth in greater detail below. The above description is intended as a non-limiting and general overview of environment 100.

Example License

The following discussion illustrates example components of a license issued by license issuer 104 to one of the content receivers 110. Although portions of the following discussion refer to the environment 100 of FIG. 1, the following discussion should not necessarily be limited to that environment 100.

As shown in FIG. 2, each license 108(a) may be issued for encrypted content 202 (association shown with a dashed, curved line) and include a content key 204, integrity key 206, signature 208 (over the keys and policy), usage policy 210, and expiration marker 212. The content, keys, and policies may be referred to herein with same or similar numbers whether altered (e.g., decrypted or re-encrypted) or not.

Example Procedures

The following discussion describes ways in which the tools may issue and/or renew licenses for entertainment content, including through reference to the previously described environment and license components. Aspects of this procedure may be implemented in hardware, firmware, or software, or a combination thereof. The procedure is shown as a set of blocks that specify operations performed by the tools, such as through one or more units, devices, or hardware and are not necessarily limited to the orders shown for performing the operations by the respective blocks. In portions of the following discussion, reference will be made to the environment 100 of FIG. 1 and license components of FIG. 2.

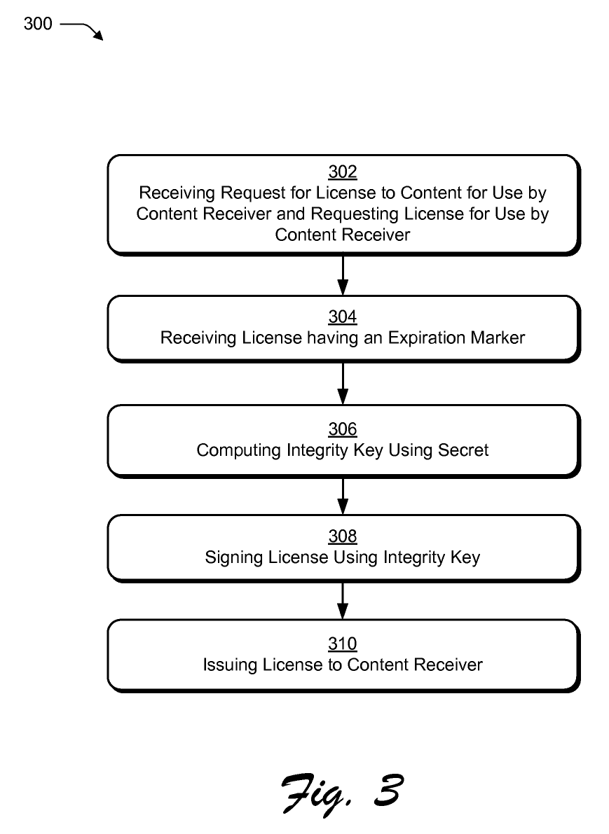

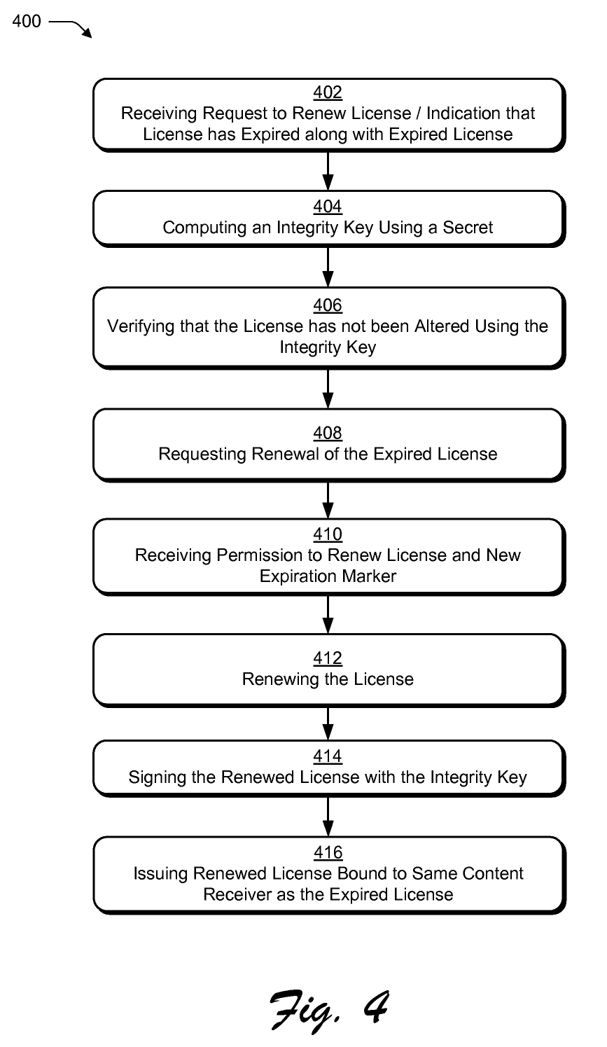

FIGS. 3 and 4 depict procedures 300 and 400 in an example implementation in which a license to entertainment content is first issued (process 300) and renewed (process 400).

Block 302 receives a request for a license to entertainment content for use by a content receiver and requests a license for the content receiver to use entertainment content. As set forth above, the license issuer may request the license via network 106 or, in the case where the license issuer is a server or other remote computing device, the license issuer may be integral with or communicate in other manners with license provider 102.

This request may include information about the content receiver, such as information sufficient to determine whether the content receiver is an entity trusted by a license provider.

Assume, for example, that content receiver 110b is a personal computer and requests a license to play a movie, e.g., “Pride and Prejudice,” for 10 days. Assume also that license issuer 104 is a tuner physically coupled to the personal computer. The personal computer requests this license from the tuner with information sufficient for the personal computer to be found to be trusted by license provider 102. The personal computer is coupled with a rendering device, such as a display with speakers, with which to play the movie. At this point the tuner has received the request for the movie with information about the personal computer.

In the ongoing embodiment the tuner requests the license from a remote source, here the license provider via network 106. The tuner requests the license and sends information sufficient for the license provider to determine that the personal computer is trusted to have access to the entertainment content. Once the license provider has done so, it encrypts the entertainment content such that it is bound to that particular content receiver. To do so it may encrypt the entertainment content with a public key of a private/public key pair of the personal computer. The private key of the personal computer is assumed to be capable of decrypting the encrypted content. In this particular example the encrypted content (e.g., encrypted content 202 of FIG. 2) may be encrypted with content key 204, which in turn is encrypted by the public key of the private/public key pair of the personal computer.

In some embodiments, the license issuer provides the content key and integrity key for use by the license provider. The license issuer may compute the integrity key based on its retained secret, either with or without a token that is associated with license.

Also, in some cases the license issuer may indicate that payment will or has been made for the license prior to the license provider providing the license.

Block 304 receives the requested license having an expiration marker. This expiration marker, e.g., marker 212 of FIG. 2, may be included in usage policy 210. This requested license may include the entertainment content governed by the license or may not. Thus, in some cases the entertainment content may be received through some other channel or at a different time but be undecryptable or otherwise unusable until the requested license is received by the content receiver.

Whatever the embodiment, the tools receive a license permitting use of entertainment content by the content receiver. As noted, this license may be bound to the content receiver, such as when the entertainment content is encrypted with a public key of a private/public key pair of the content receiver.

As shown in FIG. 2, the license received by the license issuer may include encrypted content 202, content key 204 used to encrypt the encrypted content, integrity key 206, and policy 210 having expiration marker 212. The license, however, may be received without the signature 208. This may be provided by the license issuer.

Block 306 computes an integrity key using a secret. Integrity key 206 of FIG. 2, for example, may be computed using a secret that is cryptographically secure and using computations that provide a cryptographically secure integrity key. As noted, this integrity key may be computed here or previously to create and provide to the license provider the content key and integrity key.

In the ongoing example, the tuner may retain a 128-bit secret in the hardware of the tuner. Using this secret, the tuner may compute the integrity key with a one-way cryptographic function, such as with Secure Hash Algorithm (SHA) 1, SHA 256, or AES. As noted above, the tuner may include as little as the secret in memory between issuing and renewing a license. How the tuner (or any other example license issuer) may do so is described in more detail below.

Block 308 signs the license using the integrity key. The tools, such as license issuer 104, may sign or otherwise perform computations such that at some later date the license issuer may confirm that the policy in the license has not been tampered with.

In the ongoing example the tuner creates a digital signature over a concatenation of content key 204 and integrity key 206 and policy 210 having expiration marker 212. Here we assume that the entertainment content is the movie “Pride and Prejudice”, the content key and the integrity key are encrypted to the public key of the personal computers public/private key pair, and that all of this and the policy are signed using the integrity key 206.

In some embodiments the license issuer signs the license with a one-way function using the integrity key computed with the secret and a token. This token may be public and associated with the particular entertainment content. The license issuer may concatenate the integrity key and the token and perform the function with this concatenation.

The resulting license as digitally signed includes two keys: content key 204 and integrity key 206, as shown in FIG. 2. Thus, the personal computer may decrypt the content after decrypting the content key but the tuner may not, as the tuner does not have the private key to decrypt the content key.

Block 310 issues the license to the content receiver. The license as issued may include the expiration marker, which may be an expiration time, number of uses for playing, or number of uses for recording/downloading entertainment content.

Continuing the ongoing example, assume that the expiration marker is an expiration time indicating that the movie “Pride and Prejudice” may be watched and otherwise enjoyed until such permission expires in ten days.

At some point a license may expire, either by meeting the number of recordings or downloads, meeting the number of uses (e.g., number of times a song is played), or by the period of use expiring. When this occurs or is about to occur (or anytime), the tools permit renewal of a license, such as is described in process 400 of FIG. 4.

Turning to process 400 of FIG. 4, block 402 receives a request to renew a license or an indication that a license has expired along with the expired license. As noted in FIG. 1, license issuer 104 may receive a request from one of content receivers 110 to renew a license. This license may include an expiration marker that has or is about to expire. The license is also signed with a digital signature or there is some other way in which to determine that the policy of the license has not been tampered with.

Continuing the ongoing example, assume that ten days have passed since the license to play “Pride and Prejudice” was issued. At this point the personal computer may request renewal of the license by sending the license to the tuner. Assume also that a token associated with the particular license is also sent to and received by the tuner.

Block 404 computes an integrity key using a secret, and in some cases a token as well. The license issuer, for example, may use the same secret as was used in issuing the license.

Block 406 verifies, using the integrity key, that the license has not been altered. The license issuer, for example, may re-create another (identical) integrity key and compute another digital signature to determine if the existing and new digital signatures are identical. If so, the policy of the license has not been altered.

In the ongoing example, the tuner may use the same 128-bit secret in combination with a token associated with the license to create another digital signature and, if that digital signature matches the one received with the license, determines that the license has not been altered.

Block 408 requests renewal of the license, in some cases after the authenticity of the license has been verified. The license issuer, for example, may request, either though network 106 or otherwise, permission to renew the license. This request may be performed by the license issuer determining that the user associated with the license has paid a renewal fee or that the user will be charged, or may not require additional payment.

In the ongoing example assume that the tuner requests that the license be renewed for another 10 days. This may be incident to a request by the user of the personal computer, such as with the user wanting to watch it again or because the user did not have time to watch in the first 10-day period.

Block 410 receives permission to renew the license, such as from license provider 102. The license issuer, for example, may receive permission and a new expiration marker with which to update the existing license.

In the ongoing example, the tuner communicates through satellite with the license provider and obtains permission to renew the license for 10 more days. These communications are assumed secure using manners known in the art.

Block 412 renews the license. The license issuer, for example, may update or alter the expiration marker such that the policy permits usage of the entertainment content again.

In the tuner example, the tuner alters the expiration marker in the policy to change the expiration date to add 10 more days to the period of permitted use.

Block 414 signs the renewed license using the integrity key. The license issuer may perform a one-way cryptographic function using the integrity key, such as by concatenating the integrity key with a token associated with the license and then performing a hash of the license. This helps permit the tools to renew the license again at some later date. In the ongoing example the tuner re-signs the license using the same integrity key.

Block 416 issues the renewed license bound to the same content receiver as the expired license. The tools renew the license but do not necessarily alter the encryption of the entertainment content. The entertainment content, therefore, may still only be decrypted using a symmetric key to the key used to encrypt the content. Here the content receiver may have a private key by which only it can decrypt the content key, which may in turn be used to decrypt the entertainment content.

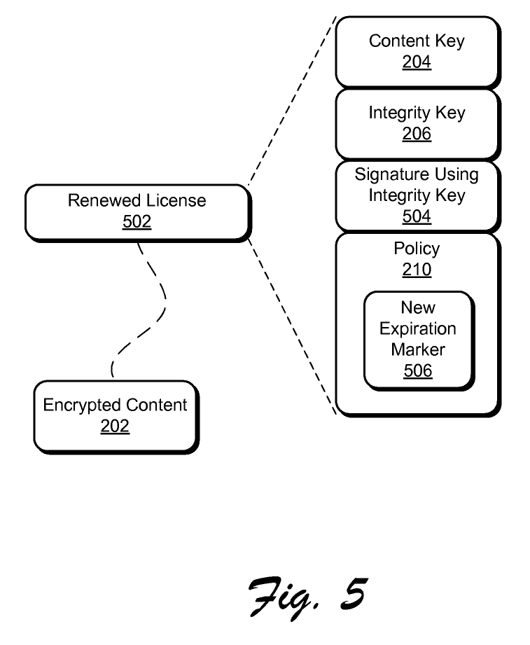

FIG. 5 sets forth an example renewed license 502. Note that encrypted content 202, content key 204, and integrity key 206 are unchanged. Signature 504 is different and a new expiration marker 506 has been added. Policy 210 is here the same other than the change with the new expiration marker.

Process 400, or parts thereof, are effective to permit renewal of license to entertainment content using little retained information. The tools may renew a license with no knowledge of the content key, integrity key, or just about anything else. In the above example a 128-bit secret was all that was retained. The tuner, with computational abilities and the secret, along with receipt of the license and token, is able to renew the license.

As noted above, the license provider may be a server or other computing device having a database and extensive other capabilities. This database and capabilities, however, are not necessarily used, thereby reducing the resources needed to renew licenses even if the license issuer has those resources.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A hardware television tuner capable of:
receiving, from a device capable of rendering entertainment content, a request to renew a license, the license permitting the device to render entertainment content indicated in the license for a period having an expiration time and signed with a digital signature;
receiving the license;
computing an integrity key using a secret;
verifying that the license has not been altered based on the digital signature and using the integrity key;
requesting renewal of the license from a remote source;
receiving permission to renew the license and a new expiration time from the remote source;
renewing the license by altering the license to include the new expiration time effective to provide a renewed license;
signing the renewed license using the integrity key; and
issuing, to the device, the renewed license signed with the integrity key effective to enable the device to use the entertainment content indicated in the license until such use expires based on the new expiration time.

2. The tuner of claim 1, further comprising performing all of the acts of claim 1 one or more times effective to enable repeated renewal of the license for each one of the one or more times.

3. The tuner of claim 1, wherein the tuner does not have an integrated and cryptographically secure database.

4. The tuner of claim 1, wherein the tuner is not capable of decrypting the entertainment content in the license.

5. The tuner of claim 1, further comprising, prior to the act of receiving the request:
receiving, from the device, a prior request for the license, the license permitting the device to render the entertainment content in the license for the period;
requesting, from the remote source, the license for use by the device;
receiving, from the remote source, the license having the expiration time;
computing the integrity key using the secret;
signing the license using the integrity key to provide the digital signature; and
issuing, to the device, the license for the period having the expiration time and signed with the digital signature.

6. The tuner of claim 1, wherein the license expires prior to the act of receiving the request and wherein the license when received is expired.

7. The tuner of claim 1, wherein the remote source is a license provider and the act of requesting is performed over the Internet.

8. One or more computer-readable media having computer-executable instructions therein that, when executed by a computing device, repeatedly renew a license to use entertainment content that is bound to a single content receiver, each act of renewal issuing a renewed license bound to that single content receiver using an integrity key computed using a secret and each act of renewal not retaining the license or the entertainment content between each act of renewal.

9. The media of claim 8, wherein each act of renewal does not require retention of information between other acts of renewal other than the secret.

10. The media of claim 8, further comprising, for each act of renewal, receiving the license, determining, with the integrity key, that the license has not been altered since it was issued by the media to the single content receiver at a prior time, receiving permission from a license provider to renew the license by altering an expiration marker in the license, altering the expiration marker in the license, signing the license using the integrity key, and issuing the license to the single content receiver.

11. The media of claim 8, wherein the media is on a computer server and the single content receiver is a computing device capable of rendering the entertainment content, is remote from the computer server, and is capable of communicating with the computer server over the Internet.

12. The media of claim 11, wherein each act of renewal is performed without requiring communication of the entertainment content over the Internet.

13. The media of claim 8, wherein the media is on a hardware card physically coupled to the single content receiver, the hardware card capable of communicating with a remote entity capable of granting permission to renew the license.

14. The media of claim 13, wherein the hardware card does not have a database capable of retaining the entertainment content or the license between acts of renewal.

15. A method implemented at least in part by a computing device, the method comprising:
issuing a license to entertainment content, the license bound to a single content receiver and having a policy that includes an expiration time or a maximum number of uses of the entertainment content, the license signed with a digital signature;
receiving the license and the digital signature after the expiration time has passed or the maximum number of uses has been reached;
verifying the integrity of the license using the digital signature;
altering the expiration time or the maximum number of uses in the license effective to renew the license;
re-signing the renewed license with a new digital signature; and
issuing the renewed license with the new digital signature effective to enable the single content provider to continue use of the entertainment content.

16. The method as described in claim 15, wherein the act of verifying the integrity of the license computes an integrity key using a secret, the integrity key being one with which the digital signature was made, and computing a second digital signature using the integrity key and, if the digital signature and the second digital signature match, concluding that the license's integrity is verified.

17. The method as described in claim 15, wherein the act of re-signing the renewed license with a new digital signature comprises computing an integrity key using a secret and using the integrity key to create the new digital signature.

18. The method as described in claim 17, wherein the act of re-signing the renewed license uses the integrity key and a public token associated with the license or the entertainment content to create the new digital signature.

19. The method as described in claim 15, wherein the single content provider is a device capable of rendering the entertainment content.

20. The method as described in claim 15, wherein the method is performed by a tuner having a secret by which an integrity key may be computed, the integrity key enabling the act of verifying the integrity of the license using the digital and also enabling the act of re-signing the renewed license with the new signature digital signature.
